(19) United States
(12) Patent Application Publication
(10) Pub. No.: US 2003/0142065 A1
(43) Pub. Date: Jul. 31, 2003

(54) Ring pointer device with inertial sensors

(76) Inventor: Kourosh Pahlavan, Palo Alto, CA (US)

Correspondence Address: KOUROSH PAHLAVAN, 2456 INDIAN DRIVE, PALO ALTO, CA, 94303, US

(21) Appl. No.: 10/057,093

(22) Filed: Jan. 28, 2002

(51) Int. Cl. G09G 5/00

(52) U.S. Cl. 345/156

(57) ABSTRACT

The invention is a ring with embedded inertial sensors, such as accelerometers and rate gyros for detecting movements of the finger, hand or object that carries it, in the free space. It is equipped with touch sensors and/or buttons that can be touched/pressed to activate the sensors and/or sense a command from the user. It has the means needed to process the signals from the said embedded sensors and peripheral buttons, convert the processed signals to such formats that can be interpreted by a computer and send the data to the said computer.

### BACKGROUND OF THE INVENTION

This invention relates, generally, to the field of computer-related interaction and input devices. Examples of these are computer mice, joysticks, touch-pads, touch-panels and alike. The invention also relates to devices such as smart pens and styli that can detect their movements and thereby enable the recognition of the character they have written. The invention also relates to such devices that are used for remote control of other devices, such as TV sets, etc. The present invention can be used for controlling the interaction with the computer and data entry through wearing the device on any segment of a finger that can move freely in space, so that its movements can be converted to positioning a computer cursor, or control and manipulate objects generated on the screen of the same or recovering the pattern of the motion for e.g. character and handwriting recognition The movements can also be used to command the computer to perform different actions. Examples are remote control of different electromechanical devices such as robots and home appliances.

Computer-related interaction and input devices include e.g. keyboards, joysticks, mice, trackballs, light pens, touch-panels, styli, etc. A function of such pointers is to position a cursor at a desired location on the computer display or to interact with objects that are drawn on the display of the computer, or simply interact with the computer by commanding it to perform different actions depending on the input from the interaction device.

U.S. Pat. Nos. 4,988,981 and 5,444,462 describe a relating idea that is implemented in form of gloves. Gloves can sense a multitude of hand and finger movements that are outside the scope of the present invention. The present invention seeks a solution that recovers movements of a single finger/hand to reconstruct that simple movement. It is also very cumbersome to wear a glove in order to do simple tasks of controlling movements in two or three-dimensional spaces. Furthermore, gloves obstruct the agility of the fingers.

U.S. Pat. No. 5,459,489 describes an elongated body that can sense the motions in space and thereby recover the data from those movements. The concept is different from the present invention most notably in that it is not in the form of a ring and it cannot take advantage of being controlled by the fingers of the user.

U.S. Pat. No. 5,481,265 describes a method in which the fingertips of the user are used for detection of typing on arbitrary surfaces. The present invention is based on a ring form that embraces finger segments, rather than fingertips. Furthermore, the present invention deals with the issue of pointing and motion detection rather than typing with fingers of the hands.

U.S. Pat. No. 5,489,922 describes an idea that uses a pair of rings that can be used as a mouse-like device. These rings can be mechanically rotated to generate the needed commands for the two needed degrees of freedom. The idea is different from the present invention in that it needs one ring for each degree of freedom and the readings are mechanical. It also covers a limited set of applications.

U.S. Pat. No. 5,638,092 describes a coil ring that is put on the user's finger. As the finger travels above the keyboard of the computer, an embedded RF receiving circuitry will detect the motion of the ring above the custom-made keyboard. This idea requires a special keyboard with embedded circuitry for generating the electromagnetic signals. It can only be applied to two-dimensional movements right above that keyboard. The present invention can however detect linear as well as angular movements in the 3-D space regardless of the distance to the device it is controlling.

U.S. Pat. No. 5,506,605 describes an idea similar to the present invention. It describes a three-dimensional mouse in form of a body that is held by a hand in a gripping position. It is addressing the general issue of interacting with a computer via inertial sensing. The present invention is based on a ring-like device that is worn on the finger and that allows the user to have his fingers free for typing or other actions.

U.S. Pat. No. 6,181,329 describes a pen-like device capable of detecting motion with six degrees of freedom and is used for handwriting recognition. The present invention is a ring-like device with integrated interaction buttons that is primarily meant to act as a pointing device, but as such is also capable of capturing movements involved in handwriting and character recognition as well.

Likewise, U.S. Pat. No. 5,181,181 addresses the problem of having a six degrees of freedom mouse in a hexahedral housing. The present invention addresses a finger-based solution integrated with the interaction buttons and in a ring-like housing.

U.S. Pat. No. 6,097,374 attempts to address some of the issues that the present invention covers. It suggests a wrist-based solution where a wrist-mounted device can generate such optical signals that can detect motion of the fingers and by combining them with the motion of two accelerometers in the wrist; one can detect keyboard typing and mouse-like motions. The present invention is a simple and cheap finger-based approach that allows the user to wear the ring, while he is typing on the keyboard. The present invention is not addressing the problem of encoding the human digits movements for decoding the typing actions. However, the present invention allows for detecting the characters drawn in the air or on a surface by means of detecting the pattern of the motion and applying a character recognition algorithm to the detected pattern. The present invention is addressing the problem of integrating sensing the motion of the finger/hand and at the same time having integrated means of activating the sensors and commanding actions (buttons mounted on the periphery of the ring). Furthermore our invention is as easy as wearing it without doing any extra action. It can be worn on any finger of the left as well as the right hand. It can even be put on toes and practically any other bar shaped moving object like the body of a pen or a bicycle handle.

U.S. Pat. No. 6,184,863 is based on a ring-like approach where the ring emits light that is received by an array of light sensitive sensors on the periphery of a screen. It is an optical and direct method and it does not place the interaction buttons needed for commanding the hosting device, e.g. the TV-set or the computer on the ring. Furthermore, it requires custom screens for embedding the optical receivers.

Some inventors have used other kind of sensors like a magnetic sensor in combination with an inclinometer, e.g. U.S. Pat. No. 5,734,371.

There are several advantages in the present invention. The uniqueness of the invention is the combination of these advantages rather than each single advantage per se:

No lift away from the keyboard: A basic problem with a computer mouse is that the user needs to lift his hand from the keyboard in order to access the mouse. This invention is carried by the user's finger, which means he will not need to lift his hand away from the keyboard and can activate the ring by just pressing a button on the ring itself. This aspect is not unique for our suggestion and others have addressed this issue in other ways, see e.g. U.S. Pat. No. 5,638,092.

Works with all computers and devices with a current pointer interface: Our suggested approach is a complete stand-alone solution that can substitute currently available pointing devices without any requirements on additional hardware or alterations to the basic computer design. In the case of a mouse substitute, it can work as a mouse with any computer that already has a mouse interface without any changes to the hardware of the computer.

It carries its own buttons: A major shortcoming of similar solutions to the problem of having a pointing device without lifting the hand is that the pointing body is not stand-alone and does not have its own buttons. That is, some other mechanism, e.g. a keyboard is necessary to accomplish the task of a completely functional pointer. This invention has buttons or touch sensors mounted on its body so that they can be pressed and act as means of signaling and activation of the internal circuitry.

Simple, cheap and small: The present invention is very simple in design and in the tethered version is actually even simpler than the traditional mouse, because it does not involve the complicated machinery involved in a mechanical mouse. It is simpler than many direct pointing devices, because its function does not depend on special arrangements on the host computer side.

Is not limited to the mouse concept: The present invention is not limited to that of a mouse. It can be used as means of drawing characters and figures in the free space or on an arbitrary surface. For instance, in combination with a mobile handset, like a pocket PC or Palm Pilot, the ring can substitute the stylus. In particular when connected wirelessly to the host device, it can be used as an input device for controlling a TV set or a car's navigation system or stereo system. It can be used by a handicapped person to drive a wheelchair or perform similar activities.

Can work directly without any additional software: The present invention, when implemented as a computer mouse for a particular family of computers, e.g. a PC or a Macintosh computer, can be directly connected to the computer without any additional software. That is, it can completely and successfully emulate a traditional computer mouse and its function will be transparent to that computer's mouse interface.

Can work with other degrees of freedom: The present invention is fully capable of performing whatever a computer mouse does. However, it can easily address motion control with all possible six degrees of freedom that an object can have in the three-dimensional space.

### BRIEF SUMMARY OF THE INVENTION

It is a main objective of the present invention to be a general purpose ring-like pointing device using inertial sensors to detect motion along and about different axes of the three dimensional space. The virtue of having its command buttons on its periphery, allows the ring to be a complete pointing device worn on a finger.

Another objective of the present invention resides in an indirect pointing apparatus for interaction with computers and other interactive devices, which are both easy to use and inexpensive.

A further objective of the present invention resides in an indirect pointing apparatus having a receiver system attachment on the host computer or interactive device which can be directly connected to the existing mouse interface of the computers and control boxes of the interactive devices as well as be built-into the mentioned hosting devices.

A still further objective of the present invention resides in an indirect pointing apparatus for use with e.g. handheld computers and cellular phones in order to not only interact with them as a pointing device, but also as a text and symbol input mechanism. The user can use the finger that carries the ring as a pen that can write symbols, characters and handwritings on a real or virtual surface and these movements are transferred to the computing unit for interpretation.

### BRIEF DESCRIPTION OF THE SEVERAL VIEWS OF THE DRAWINGS

FIG. 1 illustrates a preferred implementation of the present invention as a mouse-like device. In the figure, the ring is worn on the second segment of the index finger of the user's right hand. The first segment of his adjacent thumb can touch the three buttons mounted on the bottom left side of the ring. The midst of his thumb finger's first segment is already touching the lowest button. This button activates the motion detection and readings from the rate gyros. This button can also be used for waking up the whole unit from a power save mode. The tip of the thumb can press down buttons 1 and 2 (for numbering see FIG. 2) that functionally correspond to the left and right buttons of a standard PC mouse. Once button 3 is depressed, the user's hand/finger movements are detected by the embedded rate gyros that will measure the angular velocities that can in turn be converted to the movements in the tangential directions X and Y (see FIG. 2 for the directions) by an embedded microcontroller. The microcontroller extracts the relevant information from the calculated motion and sends a reformatted data to a radio transmission circuitry onboard the ring. The data is transmitted over a radio link to a receiving unit attached to the mouse interface of the computer. In this figure this computer is a laptop PC and the interface is a USB port. The user does not need to remove his hand from the computer to use the pointing device. He just touches button 3 and through small movements of his hand/finger brings the cursor to the destination he wants and by pressing buttons 1 and 2 can perform the click action that he wants. By holding button 3 and the other buttons he can perform the so-called dragging and by simultaneous depression of buttons 1 and 2 he can simulate a three-button mouse

FIG. 2 depicts the preferred embodiment of the ring in transparent (top) and solid (bottom) three-dimensional isometric views. The bottom image shows the solid shape of the ring. The top drawing depicts the involved components with solid or dashed lines depending on whether they are visible or invisible from the outside. The buttons are numbered as 1, 2 or 3. Buttons 1 and 2 correspond to the left and right buttons of a mouse. Button 3 activates the motion detection circuitry of the ring.

FIG. 3 illustrates three different views of the preferred implementation. The internal components are drawn with dashed lines.

FIG. 4 illustrates a host attachment unit for the preferred embodiment. The major components here are the microcontroller, the radio receiver and the USB connector. The radio receiver continuously receives the data about the movements of the ring and button depressions and transfers them to the microcontroller. The microcontroller then converts the incoming data to the format understood by the host interface. The main task of the micro-controller is controlling the flow of data and interfacing to the host attachment unit.

### DETAILED DESCRIPTION OF THE INVENTION

The current invention deploys inertial sensors such as rate gyros and accelerometers to detect motion in the space and translates this motion to numerical values comprehensible for a host computer.

In presence of motion, the said sensors generate such signals whose strength, frequency or other measurable properties depend on the momentary magnitude and direction of the motion. Usually, the sensor output is an electrical signal with its value represented by an electrical current, voltage or by a frequency that depends on the magnitude and direction of the inertial force.

The said sensors can be interfaced to a micro-controller that processes and interprets the generated signals to such data format that is useable by a communication link, or comprehensible by a computer and its peripheral interfaces.

The said micro-controller may also control a radio transmission link, and components thereof, to transmit the processed motion data to a radio receiver unit that in turn interfaces to the host computer.

These said sensors, controller and radio transmitter components along with their power supply are encapsulated in an embodiment in the shape of a ring. The radio receiver will be an integral part of the host computer or an attachment to it. This ring is formed such that it can be worn on any finger and on any segment of the digits. In general they can be mounted on any object that has the shape of a finger or a rod.

The said ring is equipped with a number of buttons or touch sensors on its periphery. These buttons enable the user to interact with the sensors and their controller device. When worn on a finger, the multitude of the components form a pointing device that can provide a host device, e.g. a computer, with position, speed and acceleration data that depend on the motion of the hand or the digit on which the ring is worn.

The current pointer technology suffers from a number of problems. The most important issue is that the user of the pointing device often wishes to perform another activity while using the pointing device. The shape and size of the devices or the way they function would not normally allow for such flexibility. An example is the computer mouse that is a separate unit; the user has to lift his hand from the keyboard in order to interact with the Graphical User Interface of the computer.

Current solutions for integration with laptops or keyboards, e.g. touch pads, still require a dislocation of the hand. Some other solutions are difficult to implement, expensive, too large or unrealistic for mass production. Yet another problem with many inventions is that they are not stand-alone solutions that can be attached to a generic computer of a particular category, i.e. the computers must often be designed to enable usage of those particular pointing devices.

The present invention offers a realistic pointing device that is capable of complex control and manipulation of objects in the 3-D space in form of a ring. It works with natural and intuitive finger/hand movements of the user. It uses inertial sensors and enjoys a very simple, cheap and robust design. Its tethered version is actually simpler than a standard mouse.

Implemented as a computer mouse, the present invention solves the fundamental problem of a traditional mouse. That is, the user does not need to lift his hand away from the keyboard in order to interact with the Graphical User Interface. It is as stand-alone as a standard mouse. That is, it can be used by any computer that is already capable of using a mouse. It simply substitutes a standard mouse without any need for additional software or device drivers on the host computer. Furthermore, it belongs to the category of general pointing devices, because it can be applied to many different interaction problems.

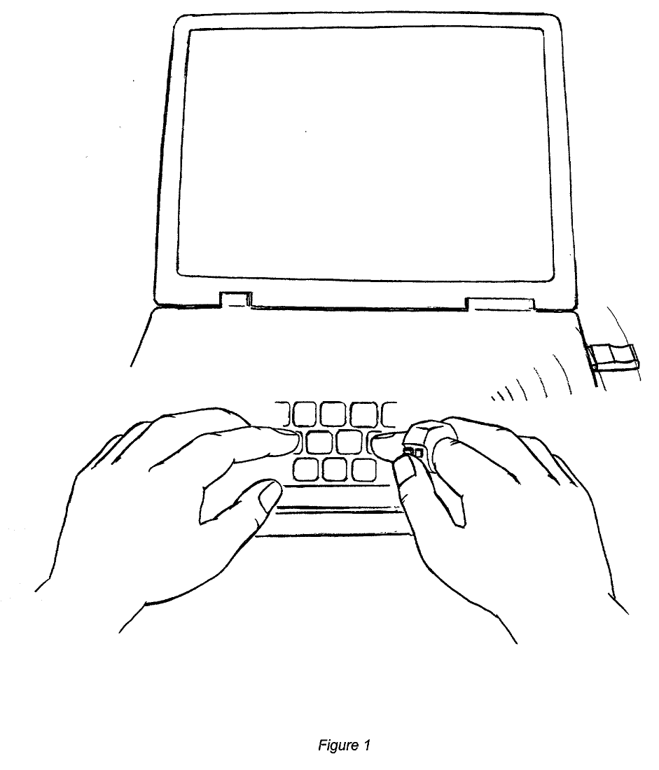

For the mouse application, the ring will need to have two accelerometers or two rate gyros for detecting motion along or about two different axes, and 2-4 buttons depending on what kind of computer it is meant to interact with. An Apple Macintosh computer will need 2 buttons, a PC will need 3 buttons, and X-Windows based computers will rather have 4 buttons. FIGS. 1, 2 and 3 illustrate such a ring for a PC. Wearing such a ring, the computer user does not need to reposition his hand away from the keyboard in order to access the pointer device. From his current typing position, the user can simply move his finger or hand above the keys in order to point at different positions on the computer screen. Usage of the ring in such a manner is illustrated in FIG. 1. In this particular case, the ring is worn by a computer user on the second segment of the index finger of his right hand and the ring is not tethered. The ring communicates with the laptop PC by means of a wireless link between the ring and an attachment to one of the laptop's communication ports. The user can freely type on the keyboard. Whenever he needs an interaction with the computer that involves a mouse device, e.g. moving the cursor and clicking on a button in the Graphical User Interface, he activates the ring by touching a side button and moves his hand in the desired directions and at desired amount. Clicking on other buttons on the periphery of the ring will results in different commands, as pressing left and right buttons on a computer mouse does.

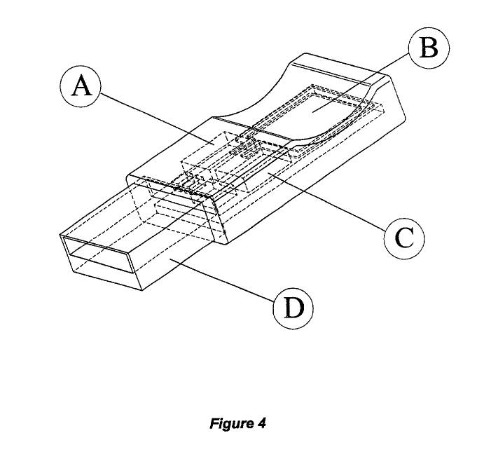

As indicated above, the communication link between the ring and the hosting computer can be a cable that links the ring to the computer. It is however more practical to use a radio link to transfer data from the ring to the computer. In this case a radio transmitter will be embedded in the ring. A corresponding radio receiver can be either embedded in the computer or attached to it as a supplementary piece of hardware via the computer mouse interface, or any other interface of the computer that allows for attachment of external devices, as illustrated in FIGS. 1 and 4.

In a more sophisticated ring, there can be as many as 3 accelerometers and 3 rate gyros, or any other combination of them that can provide the inertial information needed for controlling position and motion of a three-dimensional object in a three-dimensional space.

Other levels of complexity, in terms of number of inertial sensors and buttons, can be used as custom solutions for specific problems.

### DESCRIPTION OF THE PREFERRED EMBODIMENT

In the following section, the particular case of the preferred embodiment as a PC mouse used by a right-handed person is described. Other specific deviations from this particular case, e.g. lefthanders or other computer systems than Microsoft Windows PCs will be covered at the end of the section.

Referring first to FIG. 1, the ring is worn on the index finger of the right hand of the user. The ring can be positioned on any segment of the finger. Nonetheless, it is often more practical to wear the ring on the second segment (middle segment) of the index finger. This way the adjacent thumb can easily reach the buttons on the right side of the ring.

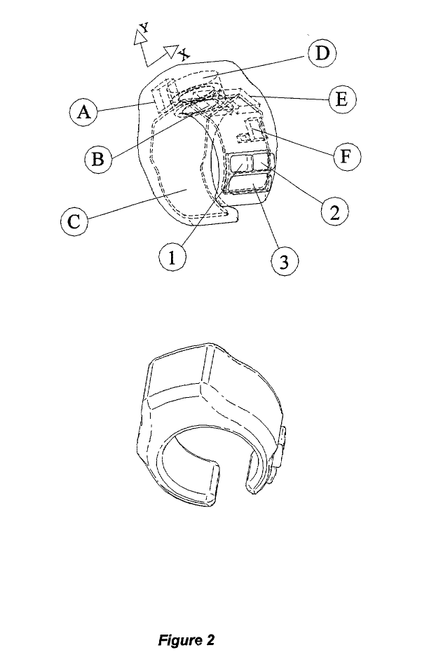

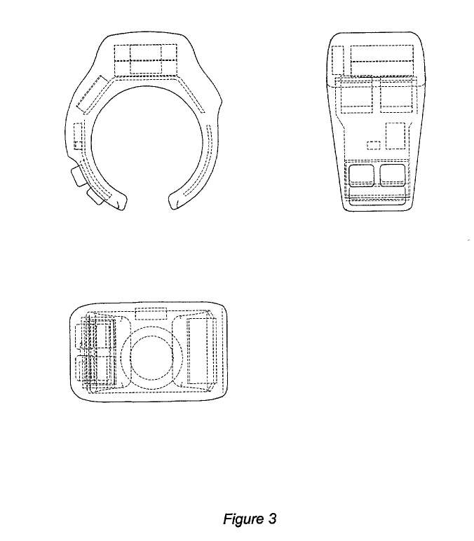

The device depicted in FIGS. 2 and 3 is not a closed ring. This is an easy way of allowing the ring size to adapt to many fingers of different thickness. This goal can of course be achieved in many different ways such as using straps and similar mechanism for resizing the ring.

Buttons 1 to 3 are arranged such that the lower part of the tip of the thumb can press and hold down button 3, while the tip of the thumb can click on buttons 1 and 2. This way, the user can simultaneously depress any combination of the three buttons. This is necessary, for example when the user needs to “drag”, i.e. hold down the left button on a mouse and simultaneously move the mouse. In the present embodiment, the user can “drag” by pressing down buttons 3 and 1 simultaneously while moving his hand.

Moving the cursor horizontally, is done by holding button 3 and moving the right hand above the keyboard plane from one side to the other. The actual movement will often be a rotation about a fictitious vertical axis going through the wrist.

Moving the cursor vertically is done by holding button 3 and moving the right hand vertically toward or away from the keyboard. The actual movement will often be a rotation about a fictitious horizontal axis going through the wrist in the plane of the keyboard.

Buttons 1 and 2 can be mapped to perform the actions of the left and right buttons on a mouse. This choice is programmable by the user.

Simultaneous depression of buttons 1 and 2 can be interpreted as depressing a fourth virtual button.

Batteries power the circuitry in the ring. Therefore, a short while after all the buttons are released the active components go to sleep mode to save battery. Depressing any button wakes the circuitry in the ring up again and the command related to that button is carried out.

The present embodiment comprises two pieces: the ring and the host attachment. The ring encompasses several components that are depicted in FIG. 2. These are the batteries, the microcontroller, the radio transmitter chip, the antenna loop, the buttons, the discrete components and the FPC (Flexible Printed Circuit Board) that carries all the components. These are all mounted into the shell of the ring.

On the host side, as depicted in FIG. 4, there is an attachment that is equipped with a radio receiver, a microcontroller, an antenna, a connector and a few discrete parts. The radio receiver is tuned to receive the incoming signals from the ring's radio transmitter. The microcontroller interfaces to the radio receiver and the host. The incoming radio signals are interpreted and reformatted to be understood by the host and the commands from the host are decoded to be executed accordingly.

The information from the rate gyros are related to the movement with which the ring is moved. This data must be integrated over time twice to achieve the angular position of the pointer at the time. The angle information along with the button status is sent to the host attachment over the radio link. The host attachment receives the information, translates it to a relative dislocation on the computer display's coordinate system and delivers it in the proper format for that particular computer's mouse interface.

By default, the host computer reacts to the presence of all available and correctly formatted signals. This means that if two users carrying their own rings with the same group identity can control the same cursor on a computer unless the host attachment is requested to listen to a specific one only.

When used for handwriting and character recognition, the ring can be used in the same way as in the case of a computer mouse. The motion will generate a pattern that can be used by a character or handwriting recognition algorithm to recognize the character or text in question.

Since the ring is functionally symmetrical, i.e. it works regardless of the ring hole orientation; a left-hander can easily use the same ring as well There are a few parameters that can be affected by turning the ring 180 degrees. The position of the buttons 1 and 2 will change place (button 2 will now be located in the front) and the direction of the X-axis will change by 180 degrees. These parameters can be programmable to allow the user to alter them according to his preferences.

In the case of other operating environments and hosts other than PCs, the number and configuration of the buttons, as well as the degrees of freedom may be different. However, for the most popular ones, e.g. Apple Macintosh and UNIX-clones running X-Windows, the same configuration may still work. The simultaneous depression of buttons 1 and 2 can be programmed to be interpreted as a virtual mid-button for the X-windows machines. For Apple Macintosh, the adaptation is even simpler: either button 1 or 2 can be used as the mouse button.

What is claimed is:

1. A pointing apparatus, comprising:
A ring-like device that is put on the finger segments equipped with inertial sensors, such as rate gyros and accelerometers, to detect the user's hand and finger motion in the 2- and 3-dimensional spaces to manipulate or control a computer cursor or computer generated objects and such objects that are displayed on a computer display or such physical or virtual objects that are controlled by a computer or electronic control system or detect movements related to drawing different characters like those of handwriting, on a real surface or on a fictitious surface in the air
Wherein the computer can be any device capable of performing computational operations at the level of complexity needed to process the flow of data generated by such a ring.
Wherein the said inertial sensors provide the information about the linear and/or angular acceleration of the carrying hand/finger, so that the acceleration information can be integrated over time to achieve speed and integrated over time again to achieve momentary position of the hand/finger equipped with buttons on the periphery of the ring, such that the buttons can be pressed by the thumb or other fingers of the same hand.
Wherein a button can be any mechanism or circuitry that can signal a depression or contact on the body of the ring, e.g. an electromechanical switch or a touch sensor.

2. A pointing apparatus, according to claim 1 wherein the inertial force can be caused by ambient forces such as gravity, body movements, or movements of the vehicle that is carrying the user.

3. A pointing apparatus, according to claim 1:
Wherein the data from the ring sensors are transmitted to the said host computer through a piece of cable and is connected to the same by means of a connector.
Wherein the circuitry needed for the function of the ring can be installed anywhere in the ring, along the cable, in the connector housing or in the host computer.

4. A pointing apparatus, according to claim 1:
Wherein the data from the ring sensors are transmitted to the said host computer through one or several wireless connections such as radio, magnetic coupling, acoustic or infrared communication links instead of cable. In this case, the transmitter will be in the ring part of the device and the receiver part will be another piece of electronic device (connected to or integrated with the host computer) that receives the transmitted signals from the transmitting ring and processes the received signal to a data format comprehensible for the said hosting computer's interface.
Wherein the receiving circuitry may be integrated with the hosting computer.

5. A pointing apparatus, according to claim 1 wherein the power to the circuitry in the ring is generated through the induced current in a coil mounted in the ring when exposed to a magnetic field that may or may not be generated by the computer.

6. A pointing apparatus, according to claims 1 to 5 wherein the actions of the buttons on the periphery of the ring are programmable so that the ring can be worn on different segments of the left hand fingers as well as right hand fingers with the same exact functionality.
